(19) United States
(12) Patent Application Publication
(10) Pub. No.: US 2017/0139594 A1
(43) Pub. Date: May 18, 2017

(54) KEY-VALUE INTEGRATED TRANSLATION LAYER

(71) Applicant: SAMSUNG ELECTRONICS CO., LTD., Suwon-si (KR)

(72) Inventors: Byoung Young AHN, San Jose, CA (US); Yang Seok KI, Palo Alto, CA (US); Inseok Stephen CHOI, Redwood City, CA (US)

(21) Appl. No.: 15/061,873

(22) Filed: Mar. 4, 2016

Related U.S. Application Data
(60) Provisional application No. 62/256,561, filed on Nov. 17, 2015.

(51) Int. Cl. G06F 3/06; G06F 17/30; G06F 12/10

(52) U.S. Cl. CPC G06F 3/061; G06F 3/064; G06F 3/0658; G06F 3/0679; G06F 12/10; G06F 17/3066; G06F 2212/1016; G06F 2212/2022; G06F 2212/222; G06F 2212/60; G06F 2212/651; G06F 2212/7201

(57) ABSTRACT

A storage device includes a non-volatile memory and a memory controller. The memory controller includes a host interface for interfacing with a host system and a memory interface for interfacing with the non-volatile memory. The storage device receives a query including a key from the host system over the host interface. The memory controller further includes a translation layer including a table indexer tree, one or more mapper tables, and one or more location mappers. The table indexer tree contains first mapping information for translating a key received over the host interface to an index. The one or more mapper tables contain second mapping information for obtaining a location of a location mapper that contains an entry associated with the index. The location mapper contains an address of data or data associated with the entry in the non-volatile memory.

### CROSS-REFERENCE TO RELATED APPLICATION(S)

This application claims the benefit of and priority to U.S. Provisional Patent Application Ser. No. 62/256,561 filed Nov. 17, 2015, the disclosure of which is incorporated herein by reference in its entirety.

### TECHNICAL FIELD

The present disclosure relates generally to storage devices and, more particularly, to a storage device including a key-value integrated translation layer.

### BACKGROUND

Non SQL (NoSQL) databases (DBs) (or key-value stores) are widely used in modern computer systems. Compared to relational databases (RDB), NoSQL DBs are simple, flexible and lightweight and provides excellent scalability and large performance gains with certain workloads. The rapid move to cloud computing and large systems with big data contributes to the growing popularity of NoSQL DBs.

Solid-state drives (SSDs) such as flash memory-based devices are used in many areas. Compared to traditional disk-based devices, SSDs have several advantages such as better performance, lower power, better shock endurance, and a smaller size. Due to these advantages, SSDs are widely used in enterprise datacenter and servers for data storage.

Despite their advantages, flash memory devices have some disadvantages. For example, a flash memory device cannot be directly overwritten; therefore, it needs an additional management layer referred to as a flash translation layer (FTL). Each block of the flash memory device should be erased before it can be written or re-programmed. Further, the unit size of each operation (e.g., an erase operation and a program operation) is different. These make in-place overwrites difficult with a flash memory. For these reasons, the flash memory device requires an additional layer of mapping from a logical domain to a physical domain. For example, a flash memory device using a traditional interface requires a FTL to translate logical block addresses (LBAs) into physical block addresses (PBAs).

Some applications and systems use flash memory devices as storage for NoSQL DBs. From a functional point of view, a flash memory storage has similar components to a NoSQL DB. The flash memory storage finds an address using a mapping table, and generates I/Os with some data manipulation by the FTL. Similarly, the NoSQL DB translates keys using an index and generates I/Os with some data manipulation.

FIG. 1 shows a traditional NoSQL DB system including overlapped components and redundant mappings. The NoSQL DB system 100 includes a NoSQL DB 110 and a flash memory storage 150 communicating over a storage interface 190. The NoSQL DB 110 receives keys 115 and operation requests (e.g., point query, range query, update, delete) from an application running on a host computer (not shown). The NoSQL DB 110 finds a data set or a location of the data set for the keys 115 using an index 116. The data manager 117 of the NoSQL DB 110 manipulates data and generates an I/O request using the data address (logical block address, or LBA) that is associated with the keys 115 in the index 116. The I/O module 118 of the NoSQL DB 110 generates the I/O request including the LBAs 130 and sends the I/O to the flash memory storage 150 over the storage interface 190. The flash memory storage 150 includes an FTL 151 that translates LBAs to PBAs using a mapping table 152, and accesses the physical blocks of the of NAND flash memory indicated by the FTL to perform the requested operations (e.g., read, write, read/modify/write (RMW), and delete).

Because the FTL communicates by receiving LBAs, the NoSQL DB has to index data and/or position of data based on the keys and generate I/O in the form of LBAs to interface with flash memory devices. The FTL of the flash memory device then translates the LBAs into PBAs to access the memory blocks of the flash memory storage. This double mapping, i.e., the first mapping from keys to LBAs and the second mapping from LBAs to PBAs, increases the overhead of the NoSQL DB system. Further, NoSQL DB s cannot control data organization and placement of the DB contents because the data position in the flash memory device may be modified by the FTL's mapping process.

Efforts have been made to improve the efficiencies of double mapping in a traditional NoSQL DB system. These efforts largely fall into two approaches. In the first approach, the NoSQL DB generates I/O patterns that can minimize the mapping effect of the FTL. For example, the NoSQL DB generates only sequential writes, similar to a log structured file system. This approach can minimize the mapping effects of the FTL, and helps placing and organizing data on the flash memory as closely as possible to the LBA addressing intended by the NoSQL DB.

However, this approach cannot completely solve the problem and still has some inefficiencies of its own. The generation of certain I/O patterns that mimic the FTL's mapping can incur an additional overhead and requires a redundant mirroring of the logic for the FTL such as garbage collection in the NoSQL DB. Although this approach mimics FTL's mapping, it cannot monitor the status of each NAND flash block and effectively map the flash blocks as well as a typical FTL does.

Even if the NoSQL DB can implement some logics to perform such optimizations with the NAND flash memory, this approach may not work with other NAND flash memory models, since each NAND memory model has different specifications, process, characteristics, size, capacity, and optimization point. Each additional non-homogenous flash drive multiplies the management overhead. Therefore, this approach cannot provide the scalability with efficiency that is required for a high performance NoSQL DB.

The second approach is to provide a key-value interface on a device side. This approach replaces LBAs with keys that can be directly called from an application layer. Since many FTLs already have a table structure (or a mapping table) for mapping LBAs to PBAs, the table can be easily transformed into a key-to-physical address mapping table. Usually, a hash table structure is used in this approach.

However, this approach also fails to solve the efficiency problem entirely. For a NoSQL DB, two types of queries can be used. The first type is a “point query” that gets single data with a single key. The second type is a “range query” that searches and gets multiple data within a range of keys. With a table-structured index like a hash table, only point query can be supported. Since the key domain in a NoSQL DB is not a discrete domain and has a table structure, it cannot find the next entry without searching for the entire key entries.

Even for the point query, this approach cannot handle biased (over weighted) keys. The key generation is entirely up to a client application of a NoSQL DB, and hashing may help to avoid bias. However, the implementation of a better hashing scheme can add the complexity of hashing and increase an overhead.

### SUMMARY

According to one embodiment, a storage device includes a non-volatile memory and a memory controller. The memory controller includes a host interface for interfacing with a host system and a memory interface for interfacing with the non-volatile memory. The storage device receives a query including a key from the host system over the host interface. The memory controller further includes a translation layer including a table indexer tree, one or more mapper tables, and one or more location mappers. The table indexer tree contains first mapping information for translating a key received over the host interface to an index. The one or more mapper tables contain second mapping information for obtaining a location of a location mapper that contains an entry associated with the index. The location mapper contains an address of data or data associated with the entry in the non-volatile memory.

According to one embodiment, a database system includes a host computer, a storage device, and a storage interface for interfacing the host computer and the storage device using a query including a key. The storage device includes a non-volatile memory and a memory controller including a translation layer, and a memory interface for interfacing with the non-volatile memory. The translation layer of the storage device includes a table indexer tree, one or more mapper tables, and one or more location mappers. The table indexer tree contains first mapping information for translating a key received over the host interface to an index. The one or more mapper tables contain second mapping information for obtaining a location of a location mapper that contains an entry associated with the index. The location mapper contains an address of data or data associated with the entry in the non-volatile memory.

According to one embodiment, a method for providing an interface to a non-volatile memory includes: receiving a query including a key from a host computer over a host interface; translating the key to an index using a table indexer tree; obtaining location information of a location mapper among one or more location mappers that contains an entry associated with the index using one or more mapper tables, and accessing data associated with the entry in the non-volatile memory using the location information.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 shows a traditional NoSQL DB system including overlapped components and redundant mappings;

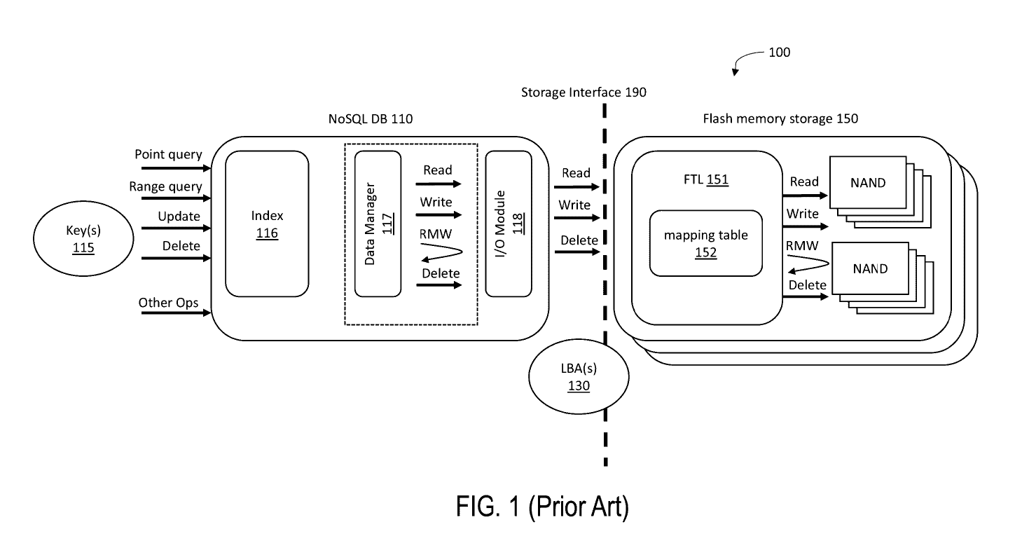

FIG. 2 shows an example of a system architecture for a prior art NoSQL DB system;

FIG. 3 shows an example of a system architecture for a NoSQL DB system, according to one embodiment;

FIG. 4 shows a structure of an example NoSQL DB system, according to one embodiment;

FIG. 5 shows operations of a three-layer index structure of an example NoSQL DB system, according to one embodiment;

FIG. 6 shows a lookup operation using the present three-layer index structure, according to one embodiment;

FIG. 7 shows an example of a range query operation, according to one embodiment;

FIG. 8 shows an example of an insert operation using the three-layer index structure, according to one embodiment;

FIG. 9 shows an example of an insert operation including a split of a location mapper, according to one embodiment; and

FIG. 10 shows an example of a delete operation, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a storage device including a key-value integrated translation layer. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The required structure for a variety of the disclosed devices and systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

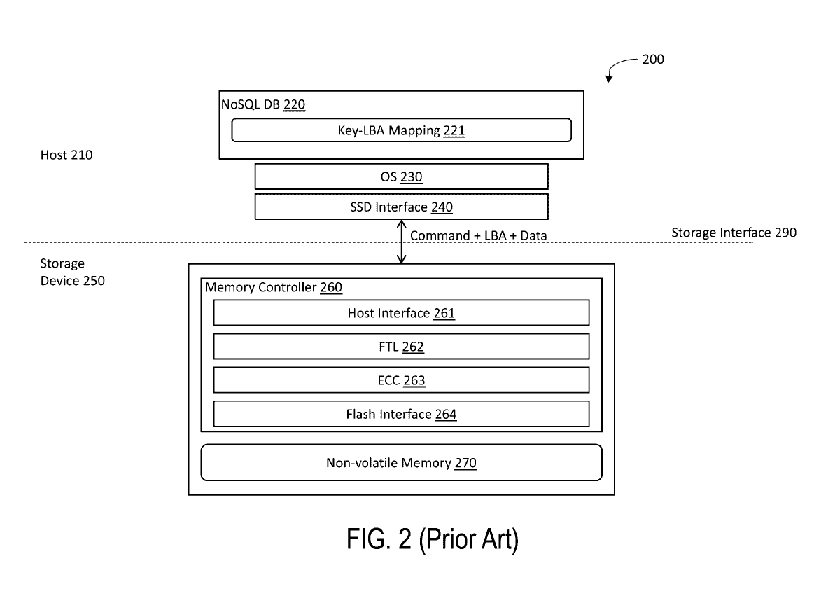

FIG. 2 shows an example of a system architecture for a prior art NoSQL DB system. The NoSQL DB system 200 includes a host computer 210 and a storage device 250 communicating over a storage interface 290. The host computer 210 include a NoSQL DB 220 that has a mapping table for key to LBA translation 221, an operating system 230, and an SSD interface 240. The examples of the SSD interface 240 include, but are not limited to, Peripheral Component Interconnect Express (PCIe), Serial Attached SCSI (SAS), Ethernet, and Serial AT Attachment (SATA). The storage device 250 includes a memory controller 260 and a non-volatile memory 270. The memory controller 260 includes a host interface 261 (e.g., PCIe, SAS, Ethernet, SATA), a flash translation layer 262, an error-correcting code (ECC) memory 263, and a flash interface 264 for interfacing with the non-volatile memory 270. The host computer 210 and the storage device 250 communicate with commands, LBAs, and data over the storage interface 290.

The present disclosure describes a storage device including a key-value flash translation layer (KV-FTL). A NoSQL DB index is integrated into the key-value FTL. An existing mapping table included in the FTL is considered as a simple version of a DB index. With a NoSQL DB index, the key-value FTL can provide a key-value interface and support NoSQL DB operations including both point query and range query. As a result, any other DB indexing may be unnecessary.

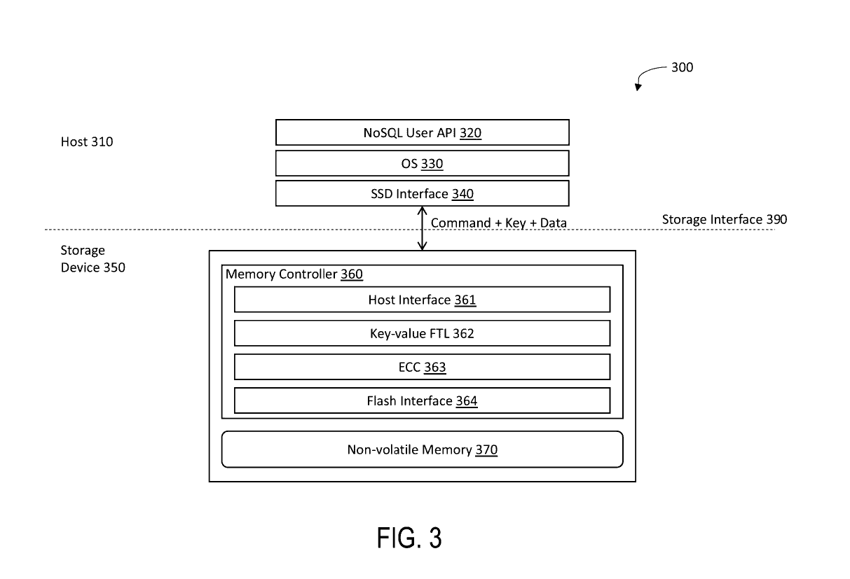

FIG. 3 shows an example of a system architecture for a NoSQL DB system, according to one embodiment. The NoSQL DB system 300 can include a host computer 310 and a storage device 350 communicating over a storage interface 390. The host computer 310 can include a NoSQL user application programming interface (API) 320, an operation system 330, and an SSD interface 340. The examples of the SSD interface 340 include, but are not limited to, PCIe, SAS, Ethernet, and SATA. The storage device 350 can include a memory controller 360 for interfacing with a non-volatile memory 370. The memory controller 360 can include a host interface 361 (e.g., PCIe, NVM Express (NVMe), SAS, Ethernet, SATA), a key-value flash translation layer 362, an error-correcting code (ECC) memory 363, and a flash interface 364. The host computer 310 and the storage device 350 can communicate with query commands, keys, and data over the storage interface 390. The non-volatile memory 370 can be of various types of non-volatile memory including, but not limited to, a flash memory, a phase-change RAM (PRAM), a spin-transfer torque magnetic random access memory (STT-MRAM), and a resistive RAM (ReRAM).

The integration of a NoSQL DB index into the key-value FTL 362 of the storage device 350 poses several challenges. One of the biggest challenges is the size of a key domain required for implementing a NoSQL DB index. An LBA space is divided in a logical block unit (e.g., 512 bytes, and 4K bytes) while a key space has neither a unit nor a space limit. Further, the LBA space is limited by a physical storage capacity of a storage device because LBAs are numbered as integers in a sequential order. For example, if the device's capacity is 1 TB and the logical block size is 4 KB, the size of LBAs is 256M (1 TB/4 KB), and the range of LBAs is 0 to 268435455.

Conversely, a key space does not have a space limit. The total number of keys (entries) stored to the storage device may be limited by the storage capacity of the storage device and the size of each entry; however the values of the keys have no relationship with the storage capacity. For example, if the maximum key size is 64 bytes (1 byte is 8 bits), there will be 2̂(64*8) possible keys, which is an enormous number compared to the LBA space. Because the size of the mapping information for keys can be huge, a hashing table may be used to maintain the mapping information inside of the storage device.

The use of a hash table, however, may not provide the efficiency or performance required for a high performance storage device required in a NoSQL DB system. Certain key patterns or I/O patterns can generate collisions within the hashing table. To resolve the issue of collision, the storage device may be required to execute additional operations to manipulate the hash table using the limited resources and capabilities of the storage device. Therefore, the use of a hash table cannot guarantee that a query time is bounded to a certain number of operations.

Another limitation of a hash table is that it cannot support range queries. For a range query, the storage device must maintain the order of each key to find the next key entry. Because hashing is a randomization scheme that can corrupt the order of keys, a hash table cannot be used. Instead, a tree structure may be used to support range queries for a NoSQL index. A tree structure would require a space in the storage device that corresponds to the size of the key space.

Due to the limited size of the memory of the storage device, a tree index can be split into smaller sized subtrees, and those subtrees may be dynamically loaded (cached) in the memory of the memory controller. To maintain the order (or hierarchy) of subtrees, certain lookup cases need multiple subtree loadings, resulting in multiple flash read operations. However, with a tree structure it is difficult to limit the number of tree traversals. For example, if the number of trees is N, the depth of the hierarchy between subtrees is log N. In this case, it is needed to load and search log N number of subtrees, and hence a query time is not predictable.

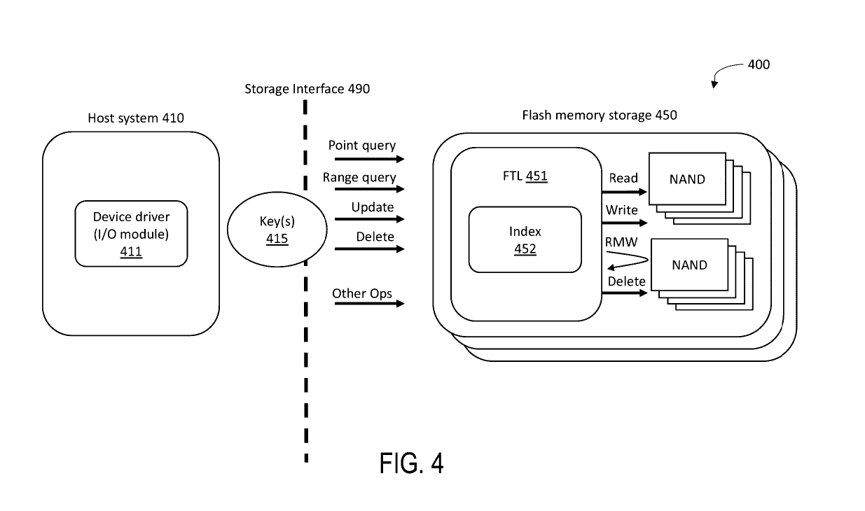

FIG. 4 shows a structure of an example NoSQL DB system, according to one embodiment of the inventive concepts. The NoSQL DB system 400 can include a host system 410 and a flash memory storage 450 including a NoSQL index integrated FTL 451. The host system 410 and the flash memory storage 450 can communicate using keys 415, query requests, and data over a storage interface 490. The query requests can include a point query, a range query, an insert query, an update query, a delete query, and a modify query.

The NoSQL index integrated in the FTL 451 can translate the keys 415 received from the host system 410 to physical NAND addresses using a NoSQL index 452. The NoSQL index integrated FTL 451 can support NoSQL DB's operations including both point queries and range queries.

According to one embodiment, the NoSQL DB system 400 can include a three-layer index structure. As illustrated in FIG. 4, the mapping structure of the FTL is substituted with a NoSQL DB's index 452 to implement the three-layer index structure. The three-layer index structure can keep the horizontal relationships between subtrees by adding a table between the subtrees. A single entry search can be performed in only one flash read operation even in a worst case. As a result, the present NoSQL DB system can provide predictable search times for both point and range queries. The three-layer index structure can improve the efficiency in a point query only system as well.

According to one embodiment, a table can be added between tree structures. The table can maintain the horizontal relationships between subtrees; therefore, the NoSQL DB system does not have to follow a hierarchy between subtrees to search for an entry. Further, the table added between tree structures can limit a depth of tree indirection, allowing the storage device to maintain a size limit for each location mapper (subtree). When a location mapper exceeds a predefined maximum size, the memory controller can split, and create a new location mapper. The hierarchy information between subtrees can be represented in the first layer's tree (i.e., a table indexer tree or a prefix tree). The storage device can limit the depth of indirection, and the depth of indirection is one even in a worst case. Whenever the storage device searches for one entry, the worst case is one tree indirection that corresponds to a flash memory read operation. With the three-layer index structure, the storage device can implement a NoSQL index in a limited-sized memory while supporting both point and range queries.

If the NoSQL DB system is required to support only point queries, the location mapper can be implemented as a table. With the table location mapper, the present three-layer structure can reduce collisions more efficiently than with a hash table. With a hash table, collisions occur due to the nature of a hashing scheme. However, with a tree structure placed prior to the hash table, collisions are based on the hashing scheme. In addition, the location mapper can be a sub hash table that determines the unit of dynamic loading, and the mapper table can be the main hash table. The first layer of the tree structure (i.e., table indexer tree) can populate multiple main hash tables, and since it is a tree structure, the storage device can use the table indexer tree to maintain relationships between the mapper tables (the second layer). Therefore, the storage device can balance and minimize collisions dynamically taking consideration of key patterns.

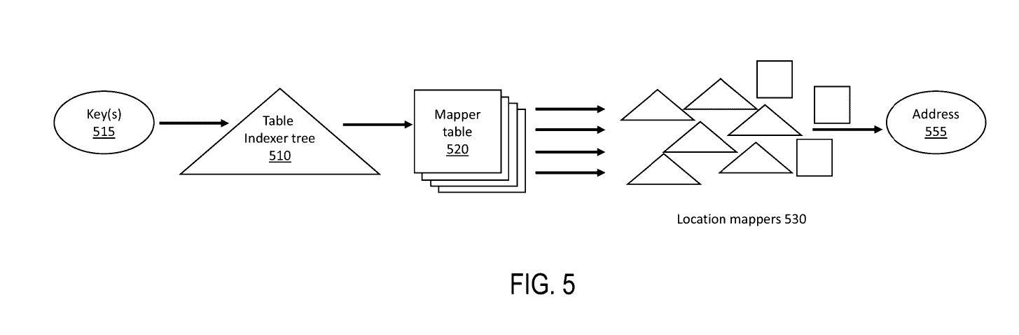

FIG. 5 shows operations of a three-layer index structure of an example NoSQL DB system, according to one embodiment of the inventive concepts. It is understood that the name of the layers used in FIG. 5 such as a table indexer, a mapper table, and location mappers are examples only, and those names should not be construed to limit the scope or features that can be implemented in those structures. Other names or labels can be given to those layers without deviating from the scope of the present disclosure. Referring to FIGS. 5 to 10, trees are represented by triangles (e.g., a table indexer tree, location mappers) and tables are represented by rectangles (e.g., mapper tables and location mappers).

Referring to FIG. 5, the tree-layer index structure of an example NoSQL DB storage device can include a first layer of a table indexer tree 510, a second layer of mapper tables 520, and a third layer of location mappers 530. The location mappers 530 can be trees, tables or a combination of trees and tables. In some embodiments, the locations mappers 530 can include data itself. The table indexer tree 510 can maintain a hierarchy between subtrees of the location mappers 530. Because a single location mapper 530 can cover many entries stored in the storage device, the table indexer tree 510 can be sufficiently small to be maintained in the memory of the storage device. Each node in the table indexer tree 510 can have an index value (or an entry number) that points to an index number (or a hash index) in the mapper table 520.

The mapper table 520 can maintain a list of location mappers (subtrees) and their positions. A lookup of the mapper table 520 requires only one memory operation; therefore, the mapper table 250 does not add an overhead or complexity to a search procedure. The mapper table 520 can be either a simple table or a hash table. Each entry in the mapper table 520 can represent a mapping between an index number (or a hash index) and the position of the location mappers 530. Since the size of the mapper table 520 does not need to be very large, the mapper table 520 can be implemented and maintained in the memory of the storage device. If the mapper table 520 cannot be fully loaded in the memory, the storage device can implement dynamic loading (caching) for table structures by merely adding one more flash read operation. In a typical case, the mapper table 520 can be fully loaded in the memory of the storage device.

The location mappers 530 can include subtrees and/or sub-tables. The location mapper 530 can maintain the location information (e.g., address 555) for data and/or data itself. The location mapper 530 can be implemented as a table, if range query needs not be supported. In such cases, point queries may be more efficient because a lookup table is faster than tree traversal. Each location mapper 530 can have a predefined maximum size. If one location mapper 530 exceeds a predefined maximum size, the location mapper 530 can be split, and a new location mapper(s) can be created. The location mapper layer can remain in the flash memory storage or cached to the memory of the memory controller. Each location mapper 530 can have a size of the unit of dynamic loading. When the first layer and second layer are cached in the memory, the location mappers 530 can be placed with only memory operations. Therefore, using the present three-layer index structure, the location of data can be found with only one flash read operation in a worst case.

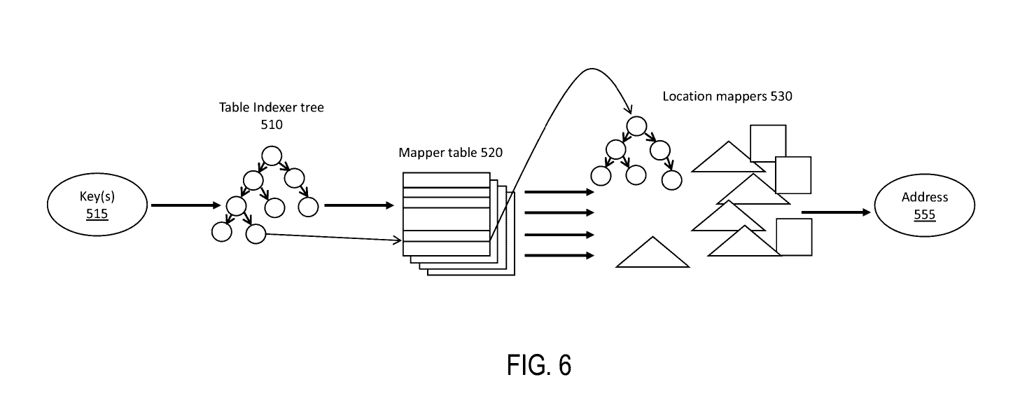

FIGS. 6 to 10 describe example operations implemented by the present three-layer index structure. All of the example operations will be explained with reference to a tree-based location mapper case. The table-based location mapper case will be similar and simpler than the tree-based location mapper case.

FIG. 6 shows a lookup operation using the present three-layer index structure, according to one embodiment. The lookup operation starts from the table indexer tree (or prefix tree) with a given key received from a host. After tree traversal, the lookup operation reaches the leaf or the end of a matching node. Using the information associated with the matching node, a hash index (or an entry number) is obtained that corresponds to a mapper table. By looking-up the mapper table with the given key, the lookup operation can locate the associated location mapper. It will be either in the memory or on a flash memory. If it is on flash memory, data is read from the flash memory. With the location mapper, the lookup operation can continue the tree traversal and finally find the location of the data (or data itself). Since the first two layer's structure can be loaded on the memory, the worst-case operation is always one flash memory read operation.

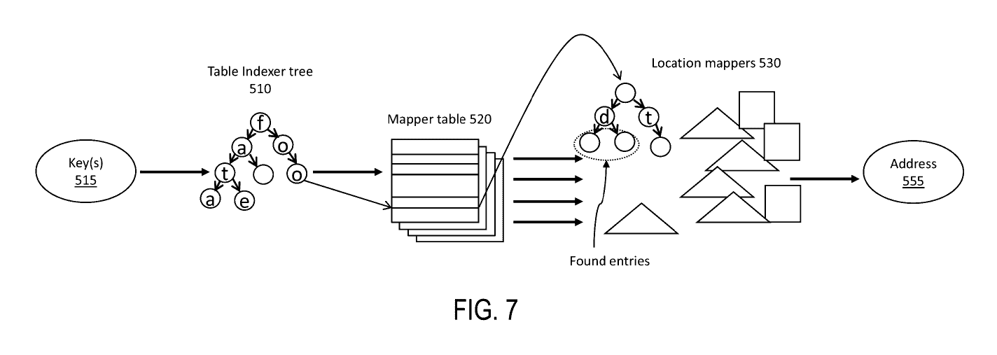

FIG. 7 shows an example of a range query operation, according to one embodiment. In the present example, a range query for “food˜fool” can start a lookup operation to find multiple matching entries in the location mappers 530. The common node “foo” associated with the range query for “food˜fool” is searched in the table indexer tree 510 to point to an index number (or a hash index) in the mapper table 520. The index number in the mapper table 520 is then mapped to the location mappers 530 to find matching entries located at the address(es) 555 of the storage device. Depending on the number of matching entries, multiple flash read operations can follow the lookup operation. In some cases, the number of matched entries in the location mappers 530 can be large. In other cases, new location mappers can be created when existing location mappers reach their size limit. If many entries should be retrieved, the operation can take more time depending on the number of matched entries.

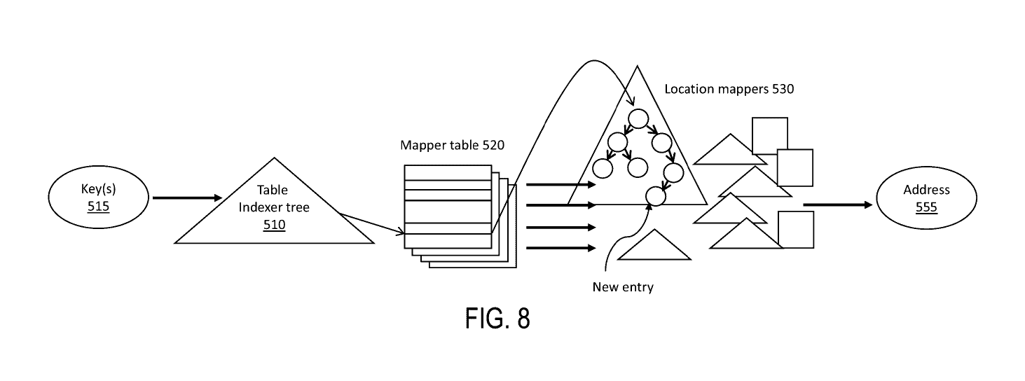

FIG. 8 shows an example of an insert operation using the three-layer index structure, according to one embodiment. To insert a new entry, an insert operation can start with a lookup operation to find a right position to insert the new entry. After the lookup operation, the insert operation can insert the new entry into the correct location mapper. If the insert operation supports modify an existing value with the NoSQL FTL, the insert operation can just modify an existing value with the similar procedure.

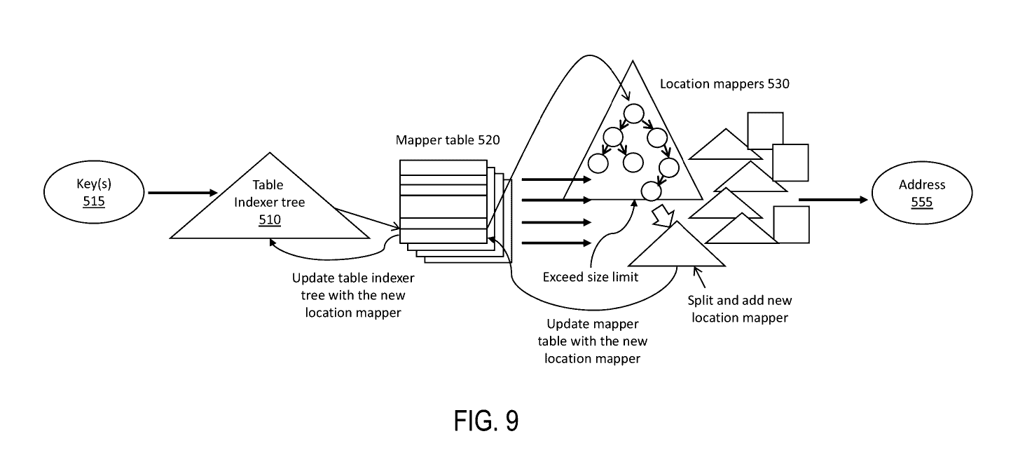

If the size of a target location mapper exceeds a predefined size, the target location mapper can be split, and a new entry is inserted in the newly created location mapper. FIG. 9 shows an example of an insert operation including a split of a location mapper, according to one embodiment. Each of the location mappers 530 can have a size limit. When a new entry added in a target location mapper causes the target location mapper to exceed its size limit, the target location mapper can be split, and a new location mapper 530 is added. The new location mapper 530 can link to the target location mapper and include the new entry. The information of the new location mapper is added into the mapper table. Following the addition in the mapper table, the table indexer tree is updated with the new entry. The three-layered index structure provides no interdependency among location mappers 530 because the information of the location mappers 530 is not contained in another location mapper but is fully contained in the structure of the prior layers of the table indexer and the mapper tables.

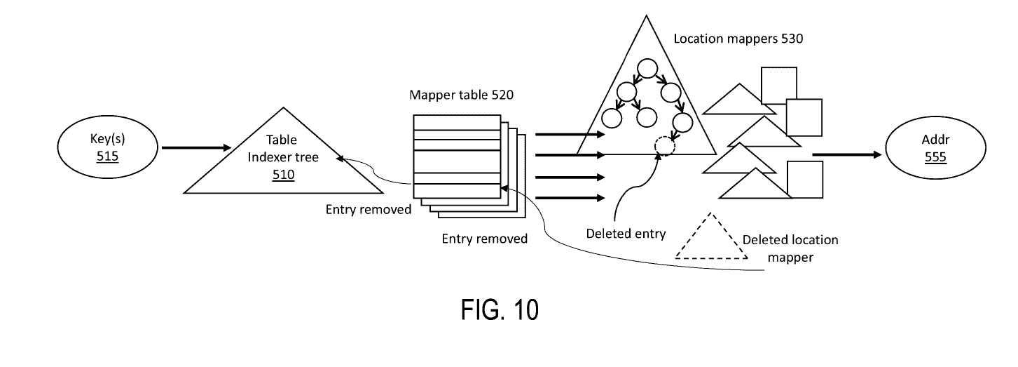

FIG. 10 shows an example of a delete operation, according to one embodiment. A delete operation is similar to an insert operation. The deletion operation starts with a lookup operation to find the position of a location mapper 530 including an entry to delete. After the lookup operation, the entry can be deleted from the location mapper 530. If an entire location mapper 530 is emptied by a delete operation, the location mapper 530 can be deleted, and the layers of the mapper table 520 and the table indexer 510 are updated with the deletion information. According to one embodiment, the present three-layer index structure can implement a merge operation of multiple location mappers when the size of two or more location mappers goes below a certain threshold. The mapper table 520 and the table indexer 510 are updated with the merge information after the two or more location mappers 530 are merged.

According to one embodiment, a storage device can include a non-volatile memory and a memory controller. The memory controller can include a host interface for interfacing with a host system and a memory interface for interfacing with the non-volatile memory. The storage device can receive a query including a key from the host system over the host interface. The memory controller can further include a translation layer including a table indexer tree, one or more mapper tables, and one or more location mappers. The table indexer tree can contain first mapping information for translating a key received over the host interface to an index. The one or more mapper tables can contain second mapping information for obtaining a location of a location mapper that contains an entry associated with the index. The location mapper can contain an address of data associated with the entry in the non-volatile memory.

The query can be one of a point query, a range query, an insert query, an update query, a delete query, and a modify query.

The table indexer tree and the one or more mapper tables can be cached in a memory of the memory controller.

The table indexer tree can include subtrees, and the subtrees can be dynamically loaded in the memory of the memory controller.

The one or more location mappers can be stored in the non-volatile memory storage or cached to the memory of the memory controller.

The memory controller can split the location mapper and adds a new location mapper when the location mapper exceeds a predetermined size limit.

The memory controller can update the table indexer tree and the one or more mapper tables after the entry is added, deleted, updated, or modified.

According to one embodiment, a database system can include a host computer, a storage device, and a storage interface for interfacing the host computer and the storage device using a query including a key. The storage device can include a non-volatile memory and a memory controller including a translation layer, and a memory interface for interfacing with the non-volatile memory. The translation layer of the storage device can include a table indexer tree, one or more mapper tables, and one or more location mappers. The table indexer tree can contain first mapping information for translating a key received over the host interface to an index. The one or more mapper tables can contain second mapping information for obtaining a location of a location mapper that contains an entry associated with the index. The location mapper can contain an address of data associated with the entry in the non-volatile memory.

The query can be one of a point query, a range query, an insert query, an update query, a delete query, and a modify query.

The memory controller can have a memory, and the table indexer tree and the one or more mapper tables can be cached in the memory.

The table indexer tree can include subtrees, and the subtrees can be dynamically loaded in the memory of the memory controller.

The one or more location mappers can be stored in the non-volatile memory storage or cached to the memory of the memory controller.

According to one embodiment, a method for providing an interface to a non-volatile memory can include: receiving a query including a key from a host computer over a host interface; translating the key to an index using a table indexer tree; obtaining location information of a location mapper among one or more location mappers that contains an entry associated with the index using one or more mapper tables, and accessing data associated with the entry in the non-volatile memory using the location information.

The query can be one of a point query, a range query, an insert query, an update query, a delete query, and a modify query.

The method can further include caching the table indexer tree and the one or more mapper tables in a memory of a memory controller.

The method can further include dynamically loading subtrees of the table indexer tree in the memory of the memory controller.

The method can further include storing the one or more location mappers in the non-volatile memory storage or caching the one or more location mappers to the memory of the memory controller.

The method can further include splitting the location mapper and adding a new location mapper when the location mapper exceeds a predetermined size limit.

The method can further include updating the table indexer tree and the one or more mapper tables after the entry is added, deleted, updated, or modified.

The above example embodiments have been described hereinabove to illustrate various embodiments of implementing a key-value integrated flash translation layer in a flash storage device. Various modifications and departures from the disclosed example embodiments will occur to those having ordinary skill in the art. The subject matter that is intended to be within the scope of the present disclosure is set forth in the following claims.

What is claimed is:

1. A storage device comprising:
a non-volatile memory; and
a memory controller including a host interface for interfacing with a host system and a memory interface for interfacing with the non-volatile memory,
wherein a query received from the host system over the host interface includes a key,
wherein the memory controller further includes a translation layer including a table indexer tree, one or more mapper tables, and one or more location mappers,
wherein the table indexer tree contains first mapping information for translating a key received over the host interface to an index,
wherein the one or more mapper tables contain second mapping information for obtaining a location of a location mapper that contains an entry associated with the index, and
wherein the location mapper contains an address of data or data associated with the entry in the non-volatile memory.

2. The storage device of claim 1, wherein the query is one of a point query, a range query, an insert query, an update query, a delete query, and a modify query.

3. The storage device of claim 1, wherein the table indexer tree and the one or more mapper tables are cached in a memory of the memory controller.

4. The storage device of claim 3, wherein the table indexer tree includes subtrees, and the subtrees are dynamically loaded in the memory of the memory controller.

5. The storage device of claim 3, wherein the one or more location mappers are stored in the non-volatile memory storage or cached to the memory of the memory controller.

6. The storage device of claim 1, wherein the memory controller splits the location mapper and adds a new location mapper when the location mapper exceeds a predetermined size limit.

7. The storage device of claim 1, wherein the memory controller updates the table indexer tree and the one or more mapper tables after the entry is added, deleted, updated, or modified.

8. A database system comprising:
a host computer;
a storage device; and
a storage interface for interfacing the host computer and the storage device using a query including a key,
wherein the storage device comprises a non-volatile memory and a memory controller including a translation layer, and a memory interface for interfacing with the non-volatile memory
wherein the translation layer of the storage device includes a table indexer tree, one or more mapper tables, and one or more location mappers,
wherein the table indexer tree contains first mapping information for translating a key received over the host interface to an index,
wherein the one or more mapper tables contain second mapping information for obtaining a location of a location mapper that contains an entry associated with the index, and
wherein the location mapper contains an address of data or data associated with the entry in the non-volatile memory.

9. The database system of claim 8, wherein the query is one of a point query, a range query, an insert query, an update query, a delete query, and a modify query.

10. The database system of claim 8, wherein the memory controller has a memory, and the table indexer tree and the one or more mapper tables are cached in the memory.

11. The database system of claim 10, wherein the table indexer tree includes subtrees, and the subtrees are dynamically loaded in the memory of the memory controller.

12. The database system of claim 10, wherein the one or more location mappers are stored in the non-volatile memory storage or cached to the memory of the memory controller.

13. A method for providing an interface to a non-volatile memory, the method comprising:
receiving a query including a key from a host computer over a host interface;
translating the key to an index using a table indexer tree;
obtaining location information of a location mapper among one or more location mappers that contains an entry associated with the index using one or more mapper tables, and
accessing data associated with the entry in the non-volatile memory using the location information.

14. The method of claim 13, wherein the query is one of a point query, a range query, an insert query, an update query, a delete query, and a modify query.

15. The method of claim 13, further comprising caching the table indexer tree and the one or more mapper tables in a memory of a memory controller.

16. The method of claim 15, further comprising dynamically loading subtrees of the table indexer tree in the memory of the memory controller.

17. The method of claim 13, further comprising storing the one or more location mappers in the non-volatile memory storage or caching the one or more location mappers to the memory of the memory controller.

18. The method of claim 13, further comprising splitting the location mapper and adding a new location mapper when the location mapper exceeds a predetermined size limit.

19. The method of claim 13, further comprising updating the table indexer tree and the one or more mapper tables after the entry is added, deleted, updated, or modified.
